(19) United States
(12) Patent Application Publication
(10) Pub. No.: US 2016/0079006 A1
(43) Pub. Date: Mar. 17, 2016

(54) ELECTRODE FOR POWER STORAGE DEVICE, POWER STORAGE DEVICE, AND METHOD FOR MANUFACTURING ELECTRODE FOR POWER STORAGE DEVICE

(71) Applicants: SUMITOMO ELECTRIC INDUSTRIES, LTD., Osaka (JP); MEIDENSHA CORPORATION, Tokyo (JP)

(72) Inventors: Akihisa HOSOE, Osaka-shi (JP); Masatoshi MAJIMA, Itami-shi (JP); Kazuki OKUNO, Itami-shi (JP); Mitsuyasu OGAWA, Itami-shi (JP); Tomoharu TAKEYAMA, Itami-shi (JP); Takayuki NOGUCHI, Tokyo (JP); Masashi YAMAMOTO, Tokyo (JP); Masamichi KURAMOTO, Tokyo (JP)

(73) Assignees: Sumitomo Electric Industries ,Ltd.; Meidensha Corporation

(21) Appl. No.: 14/889,075

(22) PCT Filed: May 7, 2014
(86) PCT No.: PCT/JP2014/062287

§ 371 Date: Nov. 4, 2015

(30) Foreign Application Priority Data
May 7, 2013 (JP) 2013-097700

(51) Int. Cl. H01G 11/36; H01G 11/26; H01G 11/86; H01M 4/133; H01M 10/0525; H01M 4/587; H01M 4/66; H01M 4/80; H01M 4/04; H01G 11/06; H01M 4/1393

(52) U.S. Cl. CPC H01G 11/36; H01G 11/06; H01G 11/26; H01G 11/86; H01M 4/133; H01M 4/1393; H01M 4/587; H01M 4/661; H01M 4/80; H01M 4/0416; H01M 10/0525; H01M 2004/021

(57) ABSTRACT

The electrode for the power storage device includes carbon nanotubes, an ionic liquid, and a three-dimensional network metal porous body having a plurality of pore portions filled with the carbon nanotubes and the ionic liquid, wherein, in pore portions exposed at a surface of the three-dimensional network metal porous body, of the plurality of pore portions, a ratio (d/D) between a pore portion diameter (D) in a first direction within the surface of the three-dimensional network metal porous body and a pore portion diameter (d) in a second direction orthogonal to the first direction within the surface of the three-dimensional network metal porous body is in a range of 0<d/D<1, and pore portions in said range account for more than or equal to 95% and less than or equal to 100% of the pore portions exposed at the surface.

### TECHNICAL FIELD

The present invention relates to an electrode for a power storage device, a power storage device, and a method for manufacturing an electrode for a power storage device.

### BACKGROUND ART

Of power storage devices, capacitors are widely used for various kinds of electric apparatuses and the like. Among capacitors of many types, an electric double layer capacitor and a lithium ion capacitor have large capacities, and are particularly attracting attention in recent years.

An electric double layer capacitor is a power storage device including a cell, a sealed container for securing electric insulation between cells and preventing liquid leakage, a power collecting electrode for taking out electricity, and a lead wire. Said cell mainly includes a pair of activated carbon electrodes facing each other, a separator for electrically separating them, and an organic electrolytic solution for exhibiting capacity.

Further, a lithium ion capacitor is a power storage device in which an electrode which can electrostatically adsorb and desorb ions, such as an activated carbon electrode, is used as a positive electrode, and an electrode which can occlude lithium ions, such as hard carbon, is used as an negative electrode.

Energy stored in an electric double layer capacitor is expressed by the following equation (1):

W=(½)CU² (1),

where W indicates stored energy (capacity), C indicates electrostatic capacitance (dependent on the surface area of an electrode), and U indicates cell voltage.

From the above equation (1), it is conceivable that improvement in electrostatic capacitance contributes to improvement in stored energy.

PTD 1 (Japanese Patent Laying-Open No. 2005-079505) discloses an “electrode material for an electric double layer capacitor, characterized by being made of a gel composition including: carbon nanotubes obtained by applying a shear force to the carbon nanotubes and subdividing the carbon nanotubes in the presence of an ionic liquid; and the ionic liquid”, to improve electrostatic capacitance in the electric double layer capacitor.

PTD 2 (Japanese Patent Laying-Open No. 2009-267340) discloses an “electrode for an electric double layer capacitor, characterized in that a sheet prepared by molding carbon nanotubes with a specific surface area of 600 to 2600 m²/g in the shape of paper is integrated with a base material which constitutes a power collector and has an irregular portion in its surface, through the irregular portion”.

### CITATION LIST

### Patent Document

PTD 1: Japanese Patent Laying-Open No. 2005-079505

PTD 2: Japanese Patent Laying-Open No. 2009-267340

### SUMMARY OF INVENTION

### Technical Problem

However, the gel composition described in PTD 1 (Japanese Patent Laying-Open No. 2005-079505) is easy to deform and is not solidified, and thus it is inconvenient to handle the gel composition as an electrode material. Moreover, it is difficult to thickly mount the gel composition on a power collecting foil, and thus there is also a problem in increasing electrostatic capacitance per unit area of the electrode.

Further, although PTD 2 (Japanese Patent Laying-Open No. 2009-267340) also describes a technique which uses foamed nickel (a three-dimensional network nickel porous body) as a base material, there is a problem that it is difficult to uniformly disperse carbon nanotubes over the base material having the irregular portion. Furthermore, gas such as CO is generated due to residual moisture and a functional group in activated carbon, and there is also a problem in increasing cell voltage. In addition, it is also desired to increase an output, in connection with the contact property between the electrode material and the power collector.

The present invention has been made in view of the aforementioned problems, and one object of the present invention is to provide: an electrode for a power storage device which has a reduced electric resistance, and which can improve the electrostatic capacitance and cell voltage of a power storage device and can improve stored energy density when used as an electrode for the power storage device; a power storage device using the electrode for the power storage device; and a method for manufacturing the electrode for the power storage device.

### Solution to Problem

The present invention is directed to an electrode for a power storage device, including carbon nanotubes, an ionic liquid, and a three-dimensional network metal porous body having a plurality of pore portions filled with the carbon nanotubes and the ionic liquid, wherein, in pore portions exposed at a surface of the three-dimensional network metal porous body, of the plurality of pore portions, a ratio (d/D) between a pore portion diameter (D) in a first direction within the surface of the three-dimensional network metal porous body and a pore portion diameter (d) in a second direction orthogonal to the first direction within the surface of the three-dimensional network metal porous body is in a range of 0<d/D<1, and pore portions in said range account for more than or equal to 95% and less than or equal to 100% of the pore portions exposed at the surface.

### Advantageous Effects of Invention

According to the present invention, an electrode for a power storage device having a reduced electric resistance can be obtained. Further, when the electrode is used for a power storage device, the electrode can improve the electrostatic capacitance and cell voltage of the power storage device, and can improve stored energy density.

### BRIEF DESCRIPTION OF DRAWINGS

FIG. 1 is an enlarged view showing an example of a surface of a three-dimensional network metal porous body.

FIG. 2 is a view showing a cross section along a line A-A′ in FIG. 1.

FIG. 3 is a view showing the three-dimensional network metal porous body having a tab lead connected thereto.

FIG. 4 is an enlarged view showing an example of a surface of a three-dimensional network metal porous body.

FIG. 5 is a view showing a cross section along a line B-B′ in FIG. 4.

FIG. 6 is a view showing the three-dimensional network metal porous body having a tab lead connected thereto.

FIG. 7 is a flowchart showing a manufacturing process of a three-dimensional network aluminum porous body.

FIG. 8(A) is an enlarged schematic view of a surface of a resin porous body. FIG. 8(B) is a view showing the resin porous body having a conductive layer formed on its surface. FIG. 8(C) is a view showing an aluminum structural body. FIG. 8(D) is a view showing an aluminum porous body.

FIG. 9 is a view schematically showing a configuration of an apparatus which performs aluminum plating processing.

FIG. 10 is a view showing an example of the resin porous body.

FIG. 11 is a view schematically showing an example of the step of compressing the three-dimensional network metal porous body.

FIG. 12 is a view schematically showing an example of the step of compressing the three-dimensional network metal porous body.

FIG. 13 is a schematic view showing an example of a cell of an electric double layer capacitor.

FIG. 14 is a schematic view showing an example of a cell of a lithium ion capacitor.

### DESCRIPTION OF EMBODIMENTS

### Description of Embodiments of Invention of Present Application

First, the contents of embodiments of the invention of the present application will be described in list form.

One embodiment of the present invention is directed to an electrode for a power storage device, including carbon nanotubes, an ionic liquid, and a three-dimensional network metal porous body having a plurality of pore portions filled with the carbon nanotubes and the ionic liquid, wherein, in pore portions exposed at a surface of the three-dimensional network metal porous body, of the plurality of pore portions, a ratio (d/D) between a pore portion diameter (D) in a first direction within the surface of the three-dimensional network metal porous body and a pore portion diameter (d) in a second direction orthogonal to the first direction within the surface of the three-dimensional network metal porous body is in a range of 0<d/D<1, and pore portions in said range account for more than or equal to 95% and less than or equal to 100% of the pore portions exposed at said surface.

Since the inside of the pore portions of the three-dimensional network metal porous body is filled with the carbon nanotubes and the ionic liquid in the electrode for the power storage device in one embodiment of the present invention, when the electrode is used as an electrode for a power storage device, the electrode can improve the electrostatic capacitance and cell voltage of the power storage device, and can improve stored energy density.

Further, since pore portions whose ratio (d/D) between the pore portion diameter (D) in the first direction and the pore portion diameter (d) in the second direction is in the range of 0<d/D<1 account for more than or equal to 95% of the plurality of pore portions of the three-dimensional network metal porous body, electric resistance exhibits anisotropy between the first direction and the second direction of the three-dimensional network metal porous body. Specifically, in the three-dimensional network metal porous body used in one embodiment of the present invention, the electric resistance in the first direction is lower than the electric resistance in the second direction. Therefore, the electrode using the three-dimensional network metal porous body has a low electric resistance in a case where it collects power in the first direction, and thus has an improved power collecting property.

Preferably, in the electrode for the power storage device in one embodiment of the present invention, the ratio between the pore portion diameter (D) in the first direction and the pore portion diameter (d) in the second direction is in a range of 0.3≦d/D≦0.8.

When the ratio (d/D) between the pore portion diameter (D) in the first direction and the pore portion diameter (d) in the second direction is less than 0.3, the shapes of the pore portions are too elongated in the first direction, and it is difficult to charge the carbon nanotubes and the ionic liquid into the pore portions. On the other hand, when the ratio (d/D) between the pore portion diameter (D) in the first direction and the pore portion diameter (d) in the second direction is more than 0.8, the anisotropy in the electric resistance of the three-dimensional network metal porous body is less likely to occur. Further preferably, the ratio (d/D) between the pore portion diameter (D) in the first direction and the pore portion diameter (d) in the second direction is 0.5≦d/D≦0.8.

Preferably, in the electrode for the power storage device in one embodiment of the present invention, a length direction of the carbon nanotubes is substantially parallel to the first direction.

When the length direction of the carbon nanotubes present inside the pore portions of the three-dimensional network metal porous body is substantially parallel to the first direction in the electrode for the power storage device, the electrode has an improved conductivity in the case where it collects power in the first direction. Further, when the electrode is used to fabricate a power storage device, the electrode can improve the energy density of the power storage device.

One embodiment of the present invention is directed to a power storage device including an electrode for a power storage device. According to the power storage device in one embodiment of the present invention, electrostatic capacitance and cell voltage can be improved, and stored energy density can be improved.

Preferably, in the power storage device in one embodiment of the present invention, a tab lead which collects power in the first direction is joined to the three-dimensional network metal porous body.

In the three-dimensional network metal porous body used for the power storage device in one embodiment of the present invention, the electric resistance (R1) in the first direction is lower than the electric resistance (R2) in the second direction. Accordingly, the electric resistance in a power collecting direction can be reduced by providing the tab lead which collects power in the first direction.

One embodiment of the present invention is directed to a method for manufacturing an electrode for a power storage device, including the steps of kneading carbon nanotubes and an ionic liquid to produce a kneaded material, and charging the kneaded material into a three-dimensional network metal porous body having a plurality of pore portions, wherein, in pore portions exposed at a surface of the three-dimensional network metal porous body, of the plurality of pore portions, a ratio (d/D) between a pore portion diameter (D) in a first direction within the surface of the three-dimensional network metal porous body and a pore portion diameter (d) in a second direction orthogonal to the first direction within the surface of the three-dimensional network metal porous body is in a range of 0<d/D<1, and pore portions in said range account for more than or equal to 95% and less than or equal to 100% of the pore portions exposed at said surface.

According to one embodiment of the present invention, an electrode for a power storage device in which a kneaded material containing carbon nanotubes and an ionic liquid is charged inside pore portions of a three-dimensional network metal porous body can be obtained. When the electrode for the power storage device is used as an electrode for a power storage device, the electrode can improve the electrostatic capacitance and cell voltage of the power storage device, and can improve stored energy density.

### Details of Embodiments of Invention of Present Application

Hereinafter, the present invention will be described based on embodiments. It should be noted that the present invention is not limited to the embodiments described below. Various modifications can be made to the embodiments described below within the scope identical and equivalent to the scope of the present invention.

### First Embodiment

### Electrode for Power Storage Device

In one embodiment of the present invention, an electrode for a power storage device includes carbon nanotubes, an ionic liquid, and a three-dimensional network metal porous body.

(Carbon Nanotube)

Examples of a carbon nanotube that can be used include a single-layer carbon nanotube (hereinafter also referred to as a single-layer CNT) in which only a single carbon layer (graphene) has a cylindrical shape, a double-layer carbon nanotube (hereinafter also referred to as a double-layer CNT) or a multilayer carbon nanotube (hereinafter also referred to as a multilayer CNT) in which a stacked body of a plurality of carbon layers has a cylindrical shape, a cup stack-type nanotube having a structure in which graphenes in the shape of a bottomless paper cup are stacked, and the like.

The shape of a carbon nanotube is not particularly limited, and both a carbon nanotube having a closed end and a carbon nanotube having an opened end can be used. Above all, it is preferable to use a carbon nanotube having a shape in which both ends are opened. When the both ends of the carbon nanotube are opened, the ionic liquid and an electrolytic solution can easily enter the inside of the carbon nanotube, and thus the contact area between the carbon nanotube and the ionic liquid and the electrolytic solution is increased. Accordingly, an electrode for a power storage device using the carbon nanotubes can increase the electrostatic capacitance of the power storage device.

The average length of the carbon nanotubes is preferably in a range of more than or equal to 100 nm and less than or equal to 2000 μm, and further preferably in a range of more than or equal to 500 nm and less than or equal to 100 μm. When the average length of the carbon nanotubes is in the range of more than or equal to 100 nm and less than or equal to 2000 μm, the carbon nanotubes disperse satisfactorily in the ionic liquid, and the carbon nanotubes can be easily held inside pore portions of the three-dimensional network metal porous body. Accordingly, the contact area between the carbon nanotubes and the ionic liquid is increased, and the electrostatic capacitance of the power storage device can be increased. Further, when the average length of the carbon nanotubes is more than or equal to 500 nm and less than or equal to 100 μm, the effect of increasing the electrostatic capacitance of the power storage device is significant.

The average diameter of the carbon nanotubes is preferably in a range of more than or equal to 0.1 nm and less than or equal to 50 nm, and further preferably in a range of more than or equal to 0.5 nm and less than or equal to 5 nm. When the average diameter of the carbon nanotubes is in the range of more than or equal to 0.1 nm and less than or equal to 50 nm, the ionic liquid and the electrolytic solution can easily enter the inside of the carbon nanotubes, and thus the contact area between the carbon nanotubes and the ionic liquid and the electrolytic solution is increased, and the electrostatic capacitance of the power storage device can be increased.

The purity of the carbon nanotubes is preferably more than or equal to 70% by mass, and further preferably more than or equal to 90% by mass. When the purity of the carbon nanotubes is less than 70% by mass, there are concerns about the reduction of a breakdown voltage and the generation of a dendrite due to the influence of a catalytic metal.

When the purity of the carbon nanotubes is more than or equal to 90% by mass, a good electrical conductivity can be achieved. Accordingly, the electrode for the power storage device fabricated using the carbon nanotubes can improve an output of the power storage device.

(Ionic Liquid)

An ionic liquid is prepared by combining an anion and a cation to have a melting point of about 100° C. or less. Examples of the anion that can be used include hexafluorophosphate (PF₆), tetrafluoroborate (BF₄), bis(trifluoromethanesulfonyl)imide (TFSI), trifluoromethanesulfonate (IFS), and bis(perfluoroethylsulfonyl)imide (BETI). Examples of the cation that can be used include an imidazolium ion having an alkyl group of a carbon number of 1 to 8, a pyridinium ion having an alkyl group of a carbon number of 1 to 8, a piperidinium ion having an alkyl group of a carbon number of 1 to 8, a pyrrolidinium ion having an alkyl group of a carbon number of 1 to 8, and a sulfonium ion having an alkyl group of a carbon number of 1 to 8.

Examples of the ionic liquid that can be used include 1-ethyl-3-methylimidazolium tetrafluoroborate (EMI-BF₄), 1-ethyl-3-methylimidazolium-bis(fluorosulfonyl)imide (EMI-FSI), 1-ethyl-3-methylimidazolium-bis (trifluoromethanesulfonyl)imide (EMI-TFSI), 1-butyl-3-methylimidazolium-bis (trifluoromethanesulfonyl)imide (BMI-TFSI), 1-hexyl-3-methylimidazolium tetrafluoroborate (HMI-BF₄), 1-hexyl-3-methylimidazolium-bis (trifluoromethanesulfonyl)imide (HMI-TFSI), 1-ethyl-3-methylimidazolium-fluorohydrogenate (EMI (FH)_{2,3}F), N,N-diethyl-N-methyl-N-(2-methoxyethyl)-tetrafluoroborate (DEME-BF₄), N,N-diethyl-N-methyl-N-(2-methoxyethyl)-bis(trifluoromethanesulfonyflimide (DEME-TFSI), N-methyl-N-propylpiperidinium bis(trifluoromethanesulfonyl)imide (PP13-TFSI), triethyl sulfonium-bis(trifluoromethanesulfonyflimide (TES-TFSI), N-methyl-N-propylpyrrolidinium-bis (trifluoromethanesulfonyl)imide (P13-FSI), triethyloctyl phosphonium-bis(trifluoromethanesulfonyl)imide (P2228-TFSI), and N-methyl-methoxymethylpyrrolidinium-tetrafluoroborate (C13-BF₄). Further, these ionic liquids may be used alone or can also be used in combination as appropriate. Furthermore, the ionic liquid may also contain a supporting salt.

When the electrode for the power storage device is used for a lithium ion capacitor, for example, an ionic liquid containing a lithium salt such as lithium-bis(fluorosulfonyl)imide (LiFSI) or lithium-bis(trifluoromethanesulfonyl)imide (LiTFSI) is used as the ionic liquid.

When the electrode for the power storage device is used for a lithium ion capacitor, a solution in which a supporting salt is dissolved in the ionic liquid is used.

Examples of the supporting salt that can be used include lithium-hexafluorophosphate (LiPF₆), lithium-tetrafluoroborate (LiBF₄), lithium-perchlorate (LiClO₄), lithium-bis(trifluoromethanesulfonyl)imide (LiN(SO₂CF₃)₂), lithium-bis(pentafluoroethanesulfonyl)imide (LiN(SO₂C₂F₅)₂), lithium-bis(pentafluoroethanesulfonyl)imide (LiBETI), lithium-trifluoromethanesulfonate (LiCF₃SO₃), lithium-bis(oxalate)borate (LiBC₄O₈), and the like.

The concentration of the supporting salt in the ionic liquid is preferably more than or equal to 0.1 mol/L and less than or equal to 5.0 mol/L, and more preferably more than or equal to 1 mol/L and less than or equal to 3.0 mol/L.

The ionic liquid can contain an organic solvent. When the ionic liquid contains an organic solvent, the viscosity of the ionic liquid is reduced. Accordingly, the electrode for the power storage device including the ionic liquid containing an organic solvent can improve the low-temperature characteristics of the power storage device.

As the organic solvent, for example, propylene carbonate (PC), dimethyl carbonate (DMC), diethyl carbonate (DEC), ethyl methyl carbonate (EMC), γ-butyrolactone (GBL), acetonitrile (AN), and the like can be used alone or in combination.

(Three-Dimensional Network Metal Porous Body)

The three-dimensional network metal porous body serves as a power collector in the electrode for the power storage device.

The three-dimensional network metal porous body is a three-dimensional network structural body having a plurality of pore portions. In the three-dimensional network metal porous body used in one embodiment of the present invention, in pore portions exposed at a surface of the three-dimensional network metal porous body, of the plurality of pore portions, a ratio (d/D) between a pore portion diameter (D) in a first direction within the surface of the three-dimensional network metal porous body and a pore portion diameter (d) in a second direction orthogonal to the first direction within the surface of the three-dimensional network metal porous body is in a range of 0<d/D<1, and pore portions in said range account for more than or equal to 95% and less than or equal to 100% of the pore portions exposed at said surface. Thereby, anisotropy in electric resistance occurs between the first direction and the second direction of the three-dimensional network metal porous body. Specifically, the electric resistance in the first direction, in which the pore portion diameter is larger, is lower than the electric resistance in the second direction. Thus, the electric resistance in the power collecting direction can be reduced by providing a tab lead in a region including an end portion in the first direction, in which the electric resistance is a lower (an end portion in a direction parallel to a direction in which the electric resistance is higher), in the three-dimensional network metal porous body.

Concerning the first direction and the second direction within the surface of the three-dimensional network metal porous body, for example, in a case where an upper surface of the three-dimensional network metal porous body in the shape of a sheet is a rectangle, the longitudinal direction can be defined as the first direction, and the width direction orthogonal thereto can be defined as the second direction. Further, the longitudinal direction can also be defined as the second direction, and the width direction orthogonal thereto can also be defined as the first direction. Furthermore, in a case where the upper surface of the three-dimensional network metal porous body in the shape of a sheet is a square, the direction of one side (for example, the vertical direction) can be defined as the first direction, and the direction of a side orthogonal thereto (for example, the lateral direction) can be defined as the second direction.

In the present specification, the “pore portion diameter of pore portions exposed at a surface of the three-dimensional network metal porous body” is obtained by shaving the surface of the electrode for the power storage device to such an extent that the skeleton of the three-dimensional network metal porous body can be observed, then magnifying the surface of the three-dimensional network metal porous body using a micrograph or the like, drawing a straight line of 1 inch (23.4 mm) in each of the first direction and the second direction, counting the number of pore portions which cross each straight line, and calculating each average value, as the pore portion diameter (D) in the first direction=25.4 mm/the number of pore portions in the first direction, and the pore portion diameter (d) in the second direction 25.4 mm/the number of pore portions in the second direction.

It should be noted that the three-dimensional network metal porous body only needs to have a shape of a sheet, and its dimensions are not particularly limited. In a case where the three-dimensional network metal porous body is adapted for industrial production of electrodes, it is only necessary to adjust its dimensions as appropriate according to a product line. For example, its dimensions can be set to 1 m (width)×200 m (length)×1 mm (thickness).

In the three-dimensional network metal porous body, pore portions in which the pore portion diameter (D) in the first direction is longer than the pore portion diameter (d) in the second direction account for more than or equal to 95% and less than or equal to 100% of the pore portions exposed at the surface of the three-dimensional network metal porous body, of the plurality of pore portions. An example of such a three-dimensional network metal porous body will be described with reference to the drawings.

FIG. 1 is an enlarged view showing an example of the surface of the three-dimensional network metal porous body, showing the orientation of the pore portions exposed at the surface of the three-dimensional network metal porous body in a case where the longitudinal direction is defined as the second direction, and the width direction orthogonal thereto is defined as the first direction.

In FIG. 1, pore portions 6 exposed at the surface of a three-dimensional network metal porous body 1 have substantially elliptical shapes, and the direction of the major axes of the elliptical shapes (direction indicated by X1 in FIG. 1) is substantially parallel to the first direction.

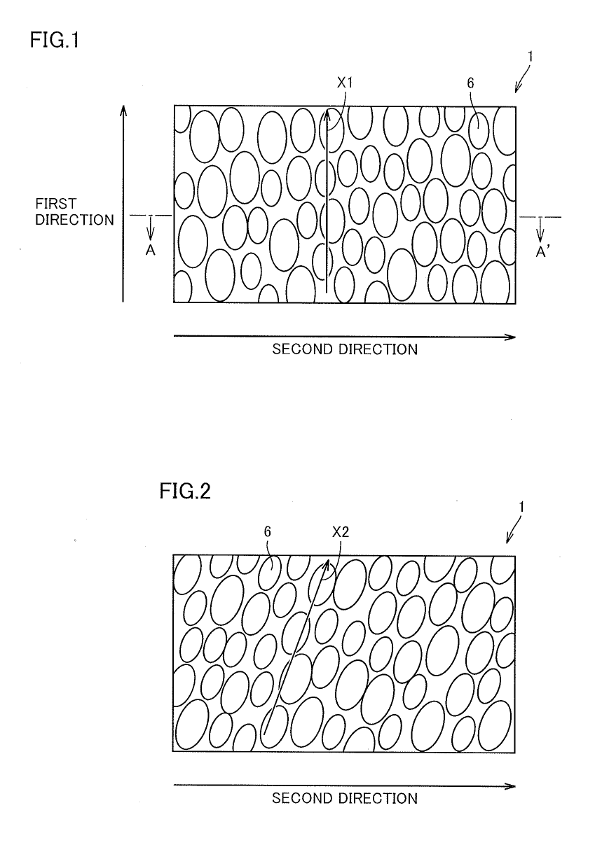

FIG. 2 is a view showing a cross section along a line A-A′ in FIG. 1. In FIG. 2, pore portions 6 exposed at the cross section along line A-A′ of three-dimensional network metal porous body 1 have substantially elliptical shapes, and the direction of the major axes of the elliptical shapes is aligned to a fixed direction (direction indicated by X2 in FIG. 2).

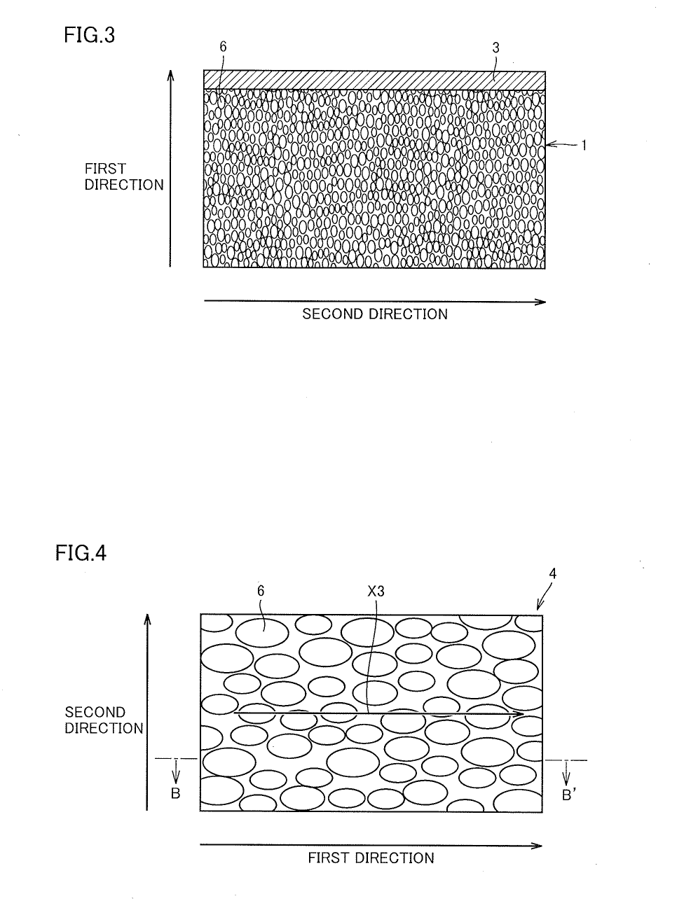

In FIG. 1, the pore portion diameter (D) in the first direction is longer than the pore portion diameter (d) in the second direction. In this case, in the three-dimensional network metal porous body, the electric resistance (R1) in the first direction is lower than the electric resistance (R2) in the second direction. Thus, the electric resistance in the power collecting direction of the electrode can be reduced by joining a tab lead 3 along an end portion in the first direction of the three-dimensional network metal porous body, as shown in FIG. 3.

FIG. 4 is an enlarged view showing an example of the surface of the three-dimensional network metal porous body, showing the orientation of the pore portions exposed at the surface of the three-dimensional network metal porous body in a case where the longitudinal direction is defined as the first direction, and the width direction orthogonal thereto is defined as the second direction.

In FIG. 4, pore portions 6 exposed at the surface of a three-dimensional network metal porous body 4 have substantially elliptical shapes, and the direction of the major axes of the elliptical shapes (direction indicated by X3 in FIG. 4) is substantially parallel to the first direction.

FIG. 5 is a view showing a cross section along a line B-B′ in FIG. 4. In FIG. 5, pore portions 6 exposed at the cross section along line B-B′ of three-dimensional network metal porous body 2 have substantially elliptical shapes, and the direction of the major axes of the elliptical shapes is aligned to a fixed direction (direction indicated by X4 in FIG. 5).

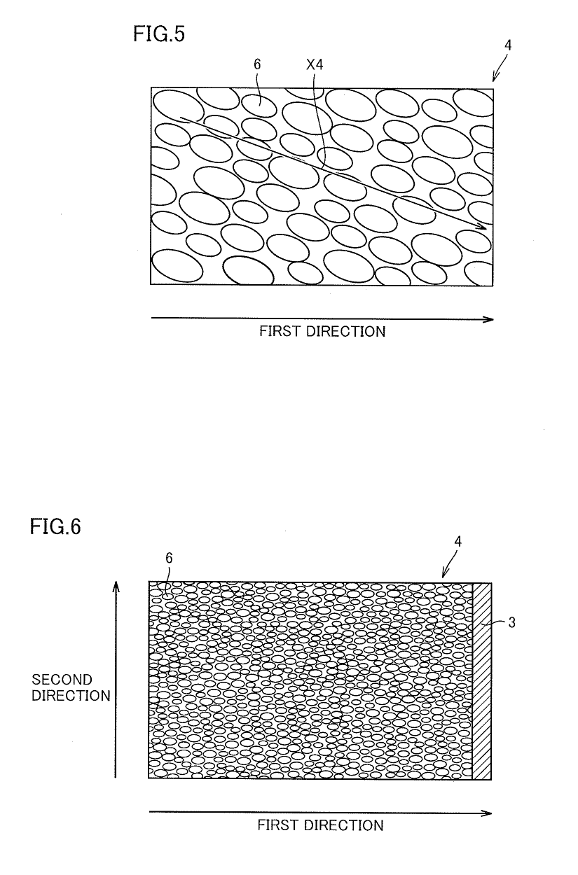

In FIG. 4, the pore portion diameter (D) in the first direction is longer than the pore portion diameter (d) in the second direction. In this case, in the three-dimensional network metal porous body, the electric resistance (R1) in the first direction is lower than the electric resistance (R2) in the second direction. Thus, the electric resistance in the power collecting direction of the electrode can be reduced by joining a tab lead along an end portion in the first direction of the three-dimensional network metal porous body, as shown in FIG. 6.

Preferably, in the pore portions exposed at the surface of the three-dimensional network metal porous body, the ratio (d/D) between the pore portion diameter (D) in the first direction and the pore portion diameter (d) in the second direction is in a range of 0.30≦d/D≦0.80. When the ratio (d/D) between the pore portion diameter (D) in the first direction and the pore portion diameter (d) in the second direction is less than 0.3, the shapes of the pore portions are too elongated in the first direction, and it is difficult to charge the carbon nanotubes and the ionic liquid into the pore portions. Further, when the ratio (d/D) between the pore portion diameter (D) in the first direction and the pore portion diameter (d) in the second direction is more than 0.80, the effect of the anisotropy in the electric resistance of the electrode as described above is reduced. From these viewpoints, the ratio (d/D) between the pore portion diameter (D) in the first direction and the pore portion diameter (d) in the second direction is more preferably in a range of 0.40≦d/D≦0.70, and further preferably in a range of 0.50≦d/D≦0.60.

The pore portion diameter (D) in the first direction of the pore portions exposed at the surface of the three-dimensional network metal porous body is preferably more than or equal to 50 μm and less than or equal to 1000 μm, and further preferably more than or equal to 200 μm and less than or equal to 900 μm, for example. Further, the pore portion diameter (d) in the second direction of the pore portions exposed at the surface of the three-dimensional network metal porous body is preferably more than or equal to 50 μm and less than or equal to 1000 μm, and further preferably more than or equal to 200 μm and less than or equal to 900 μm, for example.

When the pore portion diameter (D) in the first direction and the pore portion diameter (d) in the second direction of the three-dimensional network metal porous body are more than or equal to 50 μm, the carbon nanotubes and the ionic liquid can easily enter the inside of the pore portions of the three-dimensional network metal porous body, and a good contact property can be achieved between the carbon nanotubes and the three-dimensional network metal porous body. Accordingly, the internal resistance of the electrode is reduced, and the energy density of the power storage device can be improved. On the other hand, when the pore portion diameter (D) in the first direction and the pore portion diameter (d) in the second direction of the three-dimensional network metal porous body are less than or equal to 1000 μm, an active material can be satisfactorily held inside the pore portions without using a binder component, and a capacitor having a further sufficient strength can be obtained.

Preferably, in the three-dimensional network metal porous body, a ratio (R2/R1) between the electric resistance (R1) in the first direction and the electric resistance (R2) in the second direction of the three-dimensional network metal porous body is in a range of 1.1≦R2/R1≦2.5. Thereby, the electric resistance in the case of collecting power in the first direction can be reduced.

When the ratio (R2/R1) between the electric resistance (R1) in the first direction and the electric resistance (R2) in the second direction is less than 1.1, the effect of reducing the electric resistance in the power collecting direction is less likely to be obtained, due to a small difference between the electric resistance in the first direction and the electric resistance in the second direction. Further, when the ratio (R2/R1) between the electric resistance (R1) in the first direction and the electric resistance (R2) in the second direction is more than 2.5, the shapes of the pore portions are generally too elongated in the first direction, and thus it is difficult to charge the carbon nanotubes and the ionic liquid into the pore portions, which is not preferable. From these viewpoints, the ratio (R2/R1) between the electric resistance (R1) in the first direction and the electric resistance (R2) in the second direction is more preferably in a range of 1.3≦R2/R1≦2.0, and further preferably in a range of 1.4≦R2/R1≦1.7.

In order to set the ratio (R2/R1) between the electric resistance (R1) in the first direction and the electric resistance (R2) in the second direction of the three-dimensional network metal porous body to be in the range of 1.1≦R2/R1≦2.5, it is effective to set, for example, the ratio between the pore portion diameter (D) in the first direction and the pore portion diameter (d) in the second direction of the three-dimensional network metal porous body to be in the range of 0.3≦d/D≦0.8, as described above. That is, the ratio between the electric resistances in the first direction and the second direction can also be adjusted by adjusting the ratio between the pore portion diameters in the first direction and the second direction. For example, the ratio (R2/R1) between the electric resistances in the first direction and the second direction can be set to 1.1 by setting the ratio (d/D) between the pore portion diameters in the first direction and the second direction to 0.80, and similarly, the ratio (R2/R1) between the electric resistances can be set to 2.5 by setting the ratio (d/D) between the pore portion diameters in the first direction and the second direction to 0.30.

Preferably, in the electrode for the power storage device in one embodiment of the present invention, a metal of the three-dimensional network metal porous body includes at least one selected from the group consisting of aluminum, nickel, copper, an aluminum alloy, and a nickel alloy.

Preferably, in the electrode for the power storage device in one embodiment of the present invention, the metal of the three-dimensional network metal porous body is aluminum.

Since the electrode for the power storage device using aluminum, nickel, copper, an aluminum alloy, or a nickel alloy as the metal of the three-dimensional network metal porous body is less likely to elute even in a used voltage range of the power storage device (more than or equal to about 0 V and less than or equal to about 5 V with respect to the potential of lithium), a power storage device in which stable charging can be performed even in long-term charging and discharging can be obtained. In particular in a high voltage range (more than or equal to 3.5 V with respect to the potential of lithium), it is preferable that the metal of the three-dimensional network metal porous body includes aluminum, an aluminum alloy, or a nickel alloy, and it is further preferable that the metal of the three-dimensional network metal porous body is aluminum.

When the three-dimensional network metal porous body is used as a power collector, it is preferable to join a tab lead in the region including the end portion in the first direction of the three-dimensional network metal porous body. Specifically, it is preferable to form a belt-like compression portion compressed in a thickness direction at the end portion in the first direction of the three-dimensional network metal porous body, and join a tab lead to the compression portion by welding. In the three-dimensional network metal porous body used for the power storage device in one embodiment of the present invention, the electric resistance (R1) in the first direction is lower than the electric resistance (R2) in the second direction. Accordingly, the electric resistance in the power collecting direction can be reduced by providing a tab lead which collects power in the first direction.

The three-dimensional network metal porous body is not particularly limited, as long as pore portions whose ratio (d/D) between the pore portion diameter (D) in the first direction within the surface of the three-dimensional network metal porous body and the pore portion diameter (d) in the second direction orthogonal to said first direction within the surface of said three-dimensional network metal porous body is in the range of 0<d/D<1 account for more than or equal to 95% and less than or equal to 100% of the pore portions exposed at the surface. For example, Celmet (registered trademark) (manufactured by Sumitomo Electric Industries, Ltd.), which is fabricated by forming a metal layer on a surface of a foamed resin and then decomposing the foamed resin, can be used. Further, a metal nonwoven fabric entangled with fibrous metal, a metal foam formed by foaming a metal, a sintered body formed by sintering metal particles, or the like can also be used.

(Binder)

A binder has a role to bind a power collector and an active material in an electrode. However, since a binder resin represented by polyvinylidene fluoride (PVdF) is an insulator, the binder resin itself becomes a factor which increases the internal resistance of a power storage device including an electrode, and thus becomes a factor which reduces the efficiency of charging and discharging the power storage device.

In one embodiment of the present invention, the electrode for the power storage device can hold the carbon nanotubes which is an active material inside the pore portions of the three-dimensional network metal porous body which is a power collector, without using a binder. Thus, the electrode can be fabricated without using a binder component which is an insulator. Accordingly, since the electrode for the power storage device can be provided with the active material with a high content in unit volume of the electrode, and also has a reduced internal resistance, it can improve the electrostatic capacitance and cell voltage of the power storage device and can improve stored energy density. Therefore, it is preferable that the electrode for the power storage device does not contain a binder.

It should be noted that, in other embodiments of the present invention, the electrode for the power storage device can also use a binder. Examples of the binder that can be used include polyvinylidene fluoride-hexafluoropropylene copolymer (PVdF-FFP), polyethylene oxide modified polymethacrylate crosslinked body (PEO-PMA), polyethylene oxide (PEO), polyethylene glycol diacrylate crosslinked body (PEO-PA), polyacrylonitrile (PAN), polymethylmethacrylate (PMMA), polyvinyl alcohol (PVA), polyvinyl pyrrolidone (PVP), polyacrylic acid (PAA), polyvinyl acetate, pyridinium-1,4-diyliminocarbonyl-1,4-phenylenemethylene(PICPM)-BF₄, PICPM-PF₆, PICPM-TFSA, PICPM-SCN, PICPM-OTf, and the like. Of them, polyvinylidene fluoride-hexafluoropropylene copolymer (PVdF-HFP), polymethylmethacrylate (PMMA), or polyethylene oxide modified polymethacrylate crosslinked body (PEO-PMA) is preferably used.

(Conductive Assistant)

The electrode for the power storage device may contain a conductive assistant. The conductive assistant can reduce the resistance of the power storage device. The type of the conductive assistant is not particularly limited, and for example, acetylene black, Ketjen black, carbon fiber, natural graphite (such as scaly graphite, earthy graphite), artificial graphite, ruthenium oxide, or the like can be used. The content of the conductive assistant is preferably more than or equal to 2 parts by mass and less than or equal to 20 parts by mass with respect to 100 parts by mass of the carbon nanotubes, for example. When the content is less than 2 parts by mass, the effect of improving conductivity is reduced, and when the content is more than 20 parts by mass, electrostatic capacitance may be reduced.

<Method for Manufacturing Electrode for Power Storage Device>

(Manufacturing Process of Three-dimensional Network Metal Porous Body)

Hereinafter, a method for manufacturing a three-dimensional network aluminum porous body as an example of the three-dimensional network metal porous body will be described.

In the following, an example where an aluminum plating method is adopted as a method for forming an aluminum film on a surface of a urethane resin porous body will be described with reference to the drawings. The parts designated by the same reference numerals in the drawings referred to below are identical or corresponding parts. It should be noted that the present invention is not limited thereto, and is defined by the scope of the claims, and is intended to include any modifications within the scope and meaning equivalent to the scope of the claims.

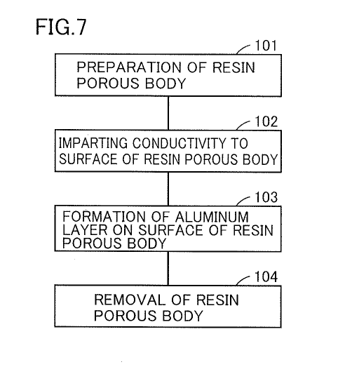

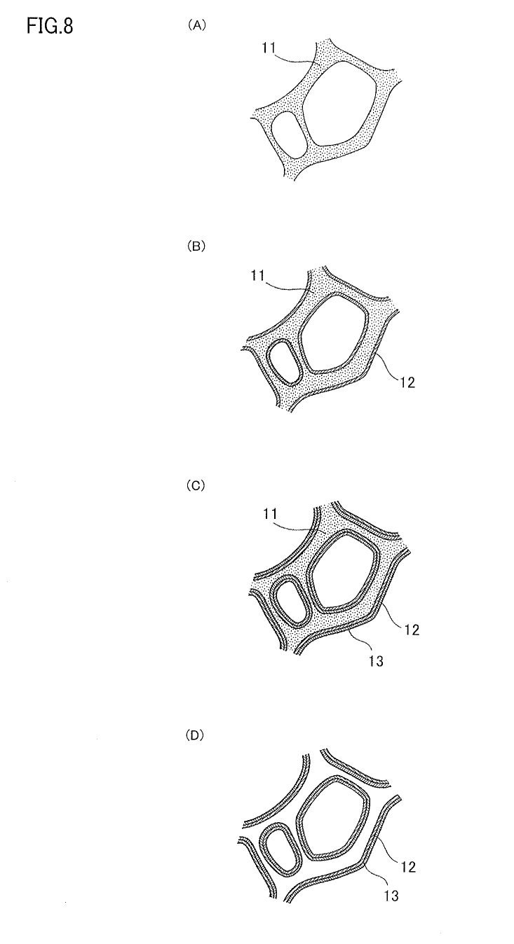

FIG. 7 is a flowchart showing a manufacturing process of an aluminum porous body. Further, FIG. 8(A) to FIG. 8(D) schematically show how an aluminum plating film is formed using a resin porous body as a core material, corresponding to the flowchart. A flow of the entire manufacturing process will be described with reference to these drawings. First, preparation of a resin porous body serving as a base body (101) is performed. FIG. 8(A) is an enlarged schematic view showing, in an enlarged manner, a surface of a resin porous body having communication pores, as an example of the resin porous body. Pores are formed in a resin porous body 11 which serves as a skeleton. Next, imparting conductivity to the surface of the resin porous body (102) is performed. Through this step, a conductive layer 12 made of a conductor is thinly formed on the surface of resin porous body 11, as shown in FIG. 8(B).

Subsequently, formation of an aluminum layer on the surface of the resin porous body (103) is performed to form an aluminum plating layer 13 on the surface of the resin porous body having the conductive layer formed thereon (FIG. 8(C)). Thereby, an aluminum structural body in which aluminum plating layer 13 is formed on the surface of resin porous body 11 serving as a base material is obtained.

Subsequently, removal of the resin porous body (104) is performed. By decomposing or otherwise vanishing resin porous body 11, an aluminum porous body including only a remaining metal layer can be obtained (FIG. 8(D)). Hereinafter, each step will be described in order.

(Preparation of Resin Porous Body)

A resin porous body having a three-dimensional network structure and having communication pores is prepared as a base body resin. As the material for the resin porous body, any resin can be selected. Examples of the material can include a foamed resin such as polyurethane, melamine, polypropylene, and polyethylene. Further, as the material for the resin porous body, for example, a material having a shape like a nonwoven fabric entangled with fibrous resin can also be used. Preferably, the resin porous body has a porosity of 80% to 98%, and a pore diameter of 50 μm to 500 μm. Since foamed urethane and foamed melamine have high porosities, have pore communication properties, and are also excellent in heat decomposability, they can preferably be used as a resin porous body.

Foamed urethane is preferable in terms of the uniformity of pores, availability, and the like, and foamed melamine is preferable in that a smaller pore diameter can be obtained.

Since the resin porous body often has residues such as a foaming agent and an unreacted monomer resulting from the step of manufacturing a foam, it is preferable to perform washing for the subsequent steps.

In the present specification, the porosity is defined by the following equation:

Porosity=(1−(weight of the resin porous body [g]/(volume of the resin porous body [cm³]×density of the material)))×100[%].

Further, the pore diameter is obtained by magnifying the surface of a resin molded body using a micrograph or the like, counting the number of pores per 1 inch (25.4 mm), and calculating an average value, as an average pore diameter=25.4 mm/the number of pores.

In order to set the ratio (d/D) between the pore portion diameter (D) in the first direction and the pore portion diameter (d) in the second direction of the pore portions exposed at the surface of the three-dimensional network metal porous body to be in the range of 0<d/D<1, it is preferable to widen a resin porous body sheet using a separated reverse V shape roller.

By placing two conveying rollers in a separated reverse V shape on the resin porous body sheet and applying a force in one direction of the resin porous body sheet to widen the resin porous body sheet as described above, the shapes of the pores in the resin porous body are uniformly extended in the one direction. Then, by performing molten salt plating in this state, the shapes of the pore portions of the obtained three-dimensional network metal porous body are also uniformly extended in the one direction.

On this occasion, the tension applied in a width direction is preferably 50 to 200 kPa.

(Imparting Conductivity to Surface of Resin Porous Body)

In order to perform electrolytic plating, processing for imparting conductivity is performed beforehand on the surface of the resin porous body. The processing for imparting conductivity is not particularly limited, as long as it can provide a layer having conductivity on the surface of the resin porous body, and any method can be selected, including, for example, electroless plating of a conductive metal such as nickel, deposition and sputtering of aluminum or the like, and application of a conductive paint containing conductive particles such as carbon powder, aluminum powder, or the like.

(Formation of Aluminum Layer on Surface of Resin Porous Body)

Examples of a method for forming an aluminum layer on the surface of the resin porous body include (i) a vapor phase method (such as a vacuum deposition method, a sputtering method, a laser ablation method), (ii) a plating method, (iii) a paste application method, and the like. Of these, a molten salt plating method is preferably used as a method suitable for mass production. Hereinafter, the molten salt plating method will be described in detail.

—Molten Salt Plating—

Electrolytic plating is performed in a molten salt to form an aluminum plating layer on the surface of the resin porous body.

By performing plating of aluminum in a molten salt bath, a thick aluminum layer can be uniformly formed in particular on a surface of a complicated skeleton structure like the resin porous body having a three-dimensional network structure.

A direct current is applied in the molten salt, using the resin porous body whose surface is imparted with conductivity as a cathode, and using aluminum as an anode.

Examples of the molten salt that can be used include an organic molten salt which is an eutectic salt of an organic halide and an aluminum halide, and an inorganic molten salt which is an eutectic salt of a halide of an alkali metal and an aluminum halide. It is preferable to use an organic molten salt bath in which a salt melts at a relatively low temperature, because plating can be performed without decomposing the resin porous body serving as the base material. As the organic halide, imidazolium salt, pyridinium salt, or the like can be used, and specifically, 1-ethyl-3-methylimidazolium chloride (EMIC) or butylpyridinium chloride (BPC) is preferable.

Since the molten salt is deteriorated if moisture and oxygen mix into the molten salt, it is preferable to perform plating under an atmosphere of an inert gas such as nitrogen, argon, or the like, and under a sealed environment.

As the molten salt bath, a molten salt bath containing nitrogen is preferable, and in particular an imidazolium salt bath is preferably used. When a salt which melts at a high temperature is used as a molten salt, the resin is dissolved or decomposed in the molten salt faster than the growth of a plating layer, and thus it is impossible to form a plating layer on the surface of the resin porous body. The imidazolium salt bath can be used even at a relatively low temperature, without affecting the resin. As the imidazolium salt, a salt containing an imidazolium cation having an alkyl group at 1,3 position is preferably used, and in particular, aluminum chloride-1-ethyl-3-methylimidazolium chloride (AlCl₃-EMIC)-based molten salt is most preferably used, because it has a high stability and is hardly decomposable. Plating on a foamed urethane resin, a foamed melamine resin, or the like can be performed, and the temperature of the molten salt bath is from 10° C. to 100° C., preferably from 25° C. to 45. As the temperature lowers, the current density range in which plating can be performed becomes narrow, and it becomes difficult to perform plating on the entire surface of the porous body. At a high temperature exceeding 100° C., a defect that the shape of the base material resin is impaired tends to occur.

It has been reported to add an additive agent such as xylene, benzene, toluene, or 1,10-phenanthroline to AlCl₃-EMIC in the molten salt plating of aluminum on a metal surface, for the purpose of improving smoothness of the plated surface. The inventors of the present invention have found that, particularly when aluminum plating is applied on a resin porous body having a three-dimensional network structure, specific effects on the formation of an aluminum porous body can be obtained by adding 1,10-phenanthroline. Namely, there can be obtained a first characteristic that the aluminum skeleton which forms the porous body is hardly broken, and a second characteristic that plating can be performed uniformly, with only a small difference in plating thickness between a surface portion and the inside of the porous body.

Thanks to the above two characteristics that the aluminum skeleton is hardly broken and that the plating thickness is uniform at the inside and the outside, when the completed aluminum porous body is pressed or the like, it is possible to obtain a porous body whose entire skeleton is hardly broken and which is pressed uniformly. In a case where the aluminum porous body is used as an electrode material for a battery or the like, the electrode is filled with an electrode active material and pressed to increase density, and the skeleton tends to be broken during the step of charging the active material and during pressing. Accordingly, the above characteristics are extremely effective in such an application.

According to the above description, it is preferable to add an organic solvent to the molten salt bath, and in particular, 1,10-phenanthroline is preferably used. The amount to be added to the plating bath is preferably 0.25 to 7 g/L. When the added amount is less than 0.25 g/L, the plating is poor in smoothness and is brittle, and it is difficult to obtain the effect of reducing a difference in thickness between a surface layer and the inside. Further, when the added amount exceeds 7 g/L, plating efficiency is reduced, and it is difficult to obtain a predetermined plating thickness.

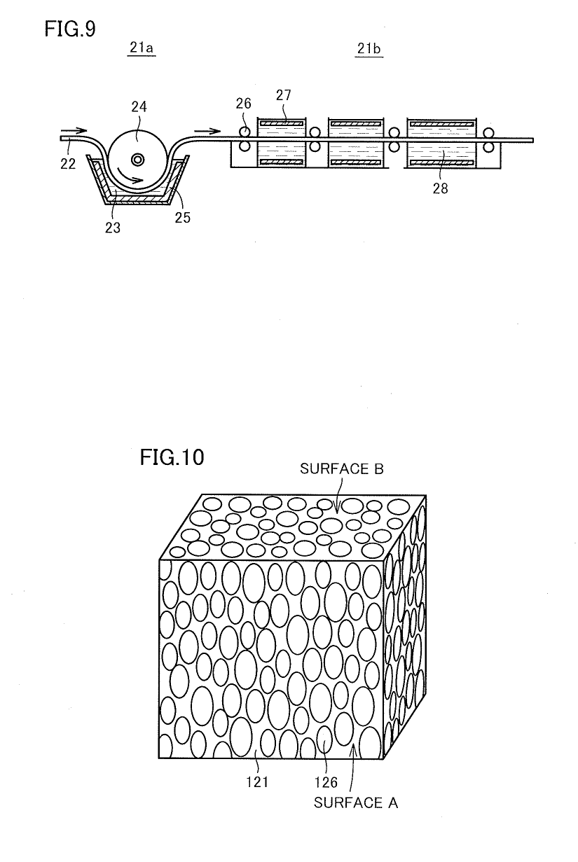

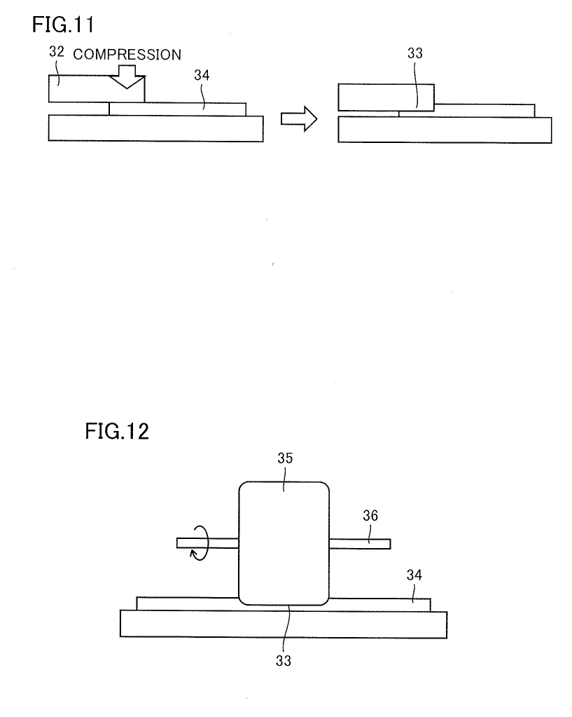

FIG. 9 is a view schematically showing a configuration of an apparatus for continuously performing aluminum plating processing on a belt-like resin porous body. FIG. 9 shows a configuration in which a belt-like resin porous body 22 having a surface imparted with conductivity is fed from the left to the right of the drawing. A first plating tank 21a includes a cylindrical electrode 24, an anode 25 made of aluminum provided at a container inner wall, and a plating bath 23. Resin porous body 22 passes through plating bath 23 along cylindrical electrode 24, and thereby a current easily flows uniformly throughout the resin porous body, and uniform plating can be obtained. A plating tank 21b is a tank for further applying plating thickly and uniformly, and is configured to repeatedly perform plating in a plurality of tanks. Plating is performed by sequentially feeding resin porous body 22 having the surface imparted with conductivity using electrode rollers 26 serving as both feed rollers and power-feeding cathodes outside the tanks, and causing resin porous body 22 to pass through plating bathes 28. Inside each of the plurality of tanks, there are anodes 27 made of aluminum provided on both sides of the resin porous body with plating bath 28 interposed therebetween, and thereby more uniform plating can be applied on the both sides of the resin porous body. A plating liquid is sufficiently removed from the plated resin porous body by blowing nitrogen, and thereafter the resin porous body is washed with water to obtain an aluminum structural body.

On the other hand, an inorganic salt bath can also be used as a molten salt, as long as the resin is not dissolved or the like. The inorganic salt bath is a two-component or multi-component salt, represented by AlCl₃—XCl (X: alkali metal). Although such an inorganic salt bath generally has a higher melting temperature when compared with an organic salt bath such as the imidazolium salt bath, it has less restrictions on environmental conditions such as moisture and oxygen, and can be put to practical use at a lower cost as a whole. When the resin is a foamed melamine resin, an inorganic salt bath at 60° C. to 150° C. is used, because the foamed melamine resin can be used at a higher temperature when compared with a foamed urethane resin.

In order to set the ratio (d/D) between the pore portion diameter (D) in the first direction and the pore portion diameter (d) in the second direction of the pore portions exposed at the surface of the three-dimensional network metal porous body to be in the range of 0<d/D<1, it is also effective to perform a method of applying a tension in one direction of the resin porous body when the resin porous body is plated with aluminum by molten salt plating. Namely, the resin porous body is pulled in the one direction and thereby is deformed, the shapes of the pores are extended in the one direction, and the pore portion diameter in a direction orthogonal to the pulling direction becomes shorter than that in the pulling direction. Then, by plating the metal in this state, a three-dimensional network metal porous body having the pore portion diameter (D) in the first direction longer than the pore portion diameter (d) in the second direction can be manufactured.

On this occasion, the tension applied in the first direction is preferably 50 to 200 kPa.

Through the above steps, the aluminum structural body having the resin porous body as a core of the skeleton is obtained. Next, the resin porous body is removed from the aluminum structural body. The resin porous body can be removed by any method, such as decomposition (dissolution) using an organic solvent, a molten salt, or a supercritical water, or heating decomposition. Here, although the method such as heating decomposition at a high temperature is simple, it is accompanied by oxidation of aluminum. Unlike nickel and the like, aluminum is difficult to reduce once it is oxidized. Thus, such a method cannot be used when aluminum is used for example as an electrode material for a battery or the like, because conductivity is lost by oxidation. Accordingly, a method of removing the resin porous body by thermal decomposition in a molten salt described below is preferably used, in order to avoid oxidation of aluminum.

(Removal of Resin Porous Body: Thermal Decomposition in Molten Salt)

Thermal decomposition in a molten salt is performed by the method described below. The aluminum structural body having the aluminum plating layer formed on the surface is immersed in a molten salt, and heated while applying an negative potential to the aluminum layer, to decompose the resin porous body as the base body resin. By applying the negative potential with the aluminum structural body being immersed in the molten salt, the resin porous body can be decomposed without oxidizing aluminum. Although the heating temperature can be selected as appropriate in accordance with the type of the resin porous body, the processing should be performed at a temperature less than or equal to the melting point of aluminum (660° C.) so as not to melt aluminum. A preferable temperature range is more than or equal to 500° C. and less than or equal to 600° C. Further, the amount of the negative potential applied is set to be less than the reduction potential of aluminum and more than the reduction potential of a cation in the molten salt.

As the molten salt used for the thermal decomposition of the resin porous body, a halide salt of an alkali metal or an alkaline earth metal that makes the electrode potential of aluminum less noble can be used. Specifically, the molten salt preferably includes at least one selected from the group consisting of lithium chloride (LiCl), potassium chloride (KCl), sodium chloride (NaCl), and aluminum chloride (AlCl₃). With such a method, an aluminum porous body having communication pores, a thin oxide layer on the surface, and a low oxygen amount can be obtained.

The three-dimensional network metal porous body can be obtained through the above manufacturing process. In the above manufacturing process, in order to set the ratio (d/D) between the pore portion diameter (D) in the first direction and the pore portion diameter (d) in the second direction of the pore portions exposed at the surface of the three-dimensional network metal porous body to be in the range of 0<d/D<1, there has been used the method of widening the resin porous body sheet using a separated reverse V shape roller, or the method of applying a tension in one direction of the resin porous body when the resin porous body is plated with aluminum by molten salt plating.

As another method for setting the ratio (d/D) between the pore portion diameter (D) in the first direction and the pore portion diameter (d) in the second direction of the pore portions exposed at the surface of the three-dimensional network metal porous body to be in the range of 0<d/D<1, there can be used a method of fabricating a three-dimensional network metal porous body using a resin porous body in which the shapes of pore portions have a directivity, the resin porous body being obtained by manufacturing a resin porous body in the shape of a prism such as a rectangular parallelepiped or a cube, and thereafter adjusting the slicing direction of the resin porous body.

Here, it is considered that the shapes of the pores in the resin porous body tend to be substantially ellipsoids due to gravity.

Therefore, by slicing the resin porous body in the shape of a prism along a plane, the shapes of pore portions exposed at a cut surface can have a directivity. Namely, the shapes of the pore portions at the cut surface can be adjusted depending on the direction of the plane along which the resin porous body is sliced.

For example, in the case of a resin porous body in which the shapes of pores are substantially ellipsoids as shown in FIG. 10, pore portions exposed at a surface of a sheet-like resin porous body obtained by slicing the resin porous body parallel to a surface A have substantially elliptical shapes. On the other hand, when the resin porous body is sliced parallel to a surface B, pore portions exposed at a surface of a sheet-like resin porous body have substantially circular shapes.

Consequently, when the resin porous body in the shape of a prism is sliced, it is preferable to slice the same in a direction in which pore portions whose ratio (d/D) between the pore portion diameter (D) in the first direction within the surface of the resin porous body and the pore portion diameter (d) in the second direction orthogonal to the first direction within the surface of the resin porous body is in the range of 0<d/D<1 account for more than or equal to 95% and less than or equal to 100% of the pore portions of the resin porous body exposed at the cut surface (surface of the sheet).

Next, a process for manufacturing an electrode using the three-dimensional network metal porous body obtained as described above will be described.

(Step of Obtaining Kneaded Material)

First, the carbon nanotubes and the ionic liquid are kneaded to obtain a kneaded material. For example, a kneaded material in which the active material is dispersed uniformly in the ionic liquid can be obtained by kneading them for more than or equal to 10 minutes to about 120 minutes, using a mortar. Dispersion of the carbon nanotubes in the ionic liquid eliminates aggregation of the carbon nanotubes, and increases the specific surface area of the carbon nanotubes. Thus, when an electrode is fabricated using the kneaded material, a larger electrostatic capacitance can be obtained.

Although the kneading ratio between the carbon nanotubes and the ionic liquid is not particularly limited, when the amount of the active material in the kneaded material is for example in a range of 3% by mass to 70% by mass of the total amount of the kneaded material, such a kneaded material is easily charged into the three-dimensional network metal porous body, and thus is preferable. It should be noted that, in a case where a supporting salt or a binder is added, it can be added in the kneading step.

(Step of Charging Kneaded Material into Pore Portions of Three-Dimensional Network Metal Porous Body)

Next, the kneaded material is charged into the pore portions of the three-dimensional network metal porous body. For example, the three-dimensional network metal porous body is placed on a mesh or a porous plate or film having air permeability or liquid permeability, and the kneaded material is charged from the upper surface of the three-dimensional network metal porous body toward the lower surface (surface placed on the mesh or the plate) thereof to be rubbed into the pore portions using a squeegee or the like.

When the kneaded material is rubbed into the pore portions, it is preferable to rub the kneaded material in a direction substantially parallel to the first direction within the surface of the three-dimensional network metal porous body. The three-dimensional network metal porous body has pore portions which are elongated in the first direction. In addition, the carbon nanotubes contained in the kneaded material have elongated shapes. Accordingly, when the kneaded material is rubbed in the direction substantially parallel to the first direction, the kneaded material containing the carbon nanotubes can be efficiently charged into the pore portions.

(Step of Applying Magnetic Field to Three-Dimensional Network Metal Porous Body)

It is preferable to apply a magnetic field to the three-dimensional network metal porous body after the kneaded material is charged into the pore portions of the three-dimensional network metal porous body. By applying the magnetic field, the carbon nanotubes charged in the pore portions can be oriented in a fixed direction. By orienting the carbon nanotubes, conductivity is improved, and thus power collecting property of the electrode can be improved.

When the magnetic field is applied, it is preferable to apply the magnetic field in the direction substantially parallel to the first direction within the surface of the three-dimensional network metal porous body, such that the length direction of the carbon nanotubes is substantially parallel to said first direction. An electrode using the three-dimensional network metal porous body in which the length direction of the carbon nanotubes is substantially parallel to the first direction within the surface of the three-dimensional network metal porous body has an improved power collecting property. Further, when the electrode is used as an electrode for a power storage device, it can improve the energy density of the power storage device.

It should be noted that, in a case where a tab lead is attached, the tab lead can be attached by the steps described below.

(Step of Adjusting Thickness)

From a raw fabric roll on which a sheet of the three-dimensional network metal porous body is taken up, the sheet of the three-dimensional network metal porous body is wound off and, in the step of adjusting thickness, its thickness is adjusted to an optimum thickness and its surface is flattened, using a roller press. While the final thickness of the three-dimensional network metal porous body is determined as appropriate depending on the application of the electrode, this step of adjusting thickness is a compression step performed prior to obtaining the final thickness, and compresses the three-dimensional network metal porous body to such an extent that it has a thickness suitable for the processing in the subsequent step to be performed. As a pressing machine, a flat plate press or a roller press is used. Since a flat plate press is preferable to suppress elongation of a power collector but is not suitable for mass production, it is preferable to use a roller press which can continuously perform processing.

(Step of Welding Tab Lead)

—Compression of End Portion of Three-dimensional Network Metal Porous Body—

In a case where the three-dimensional network metal porous body is used as an electrode power collector for a secondary battery or the like, it is necessary to weld a tab lead for external leading to the three-dimensional network metal porous body. In the case of an electrode using the three-dimensional network metal porous body, since the electrode does not have a rigid metal portion, it is not possible to directly weld a lead piece to the electrode. Thus, an end portion of the three-dimensional network metal porous body is compressed into a foil to impart mechanical strength, and then the tab lead is welded to the end portion.

An example of a method for processing the end portion of the three-dimensional network metal porous body will be described. FIG. 1.1 schematically shows a compression step thereof.

As a jig for compression, a rotary roller can be used. A predetermined mechanical strength can be obtained by setting the thickness of a compression portion to more than or equal to 0.05 mm and less than or equal to 0.2 mm (for example, about 0.1 mm).

In FIG. 12, the central portion of a three-dimensional network metal porous body 34 having a width for two sheets is compressed by a rotary roller 35 serving as a jig for compression, to form a compression portion 33. After compression, the central portion of compression portion 33 is cut to obtain two electrode power collectors each having a compression portion at its end portion.

Further, a plurality of belt-like compression portions may be formed at the central portion of the three-dimensional network metal porous body using a plurality of rotary rollers, and each of the belt-like compression portions may be cut along its central line to obtain a plurality of power collectors.

—Joining of Tab Lead to Electrode—

A tab lead is joined to the compression portion at the end portion of the power collector obtained as described above. Preferably, a metal foil is used as the tab lead in order to reduce the electric resistance of the electrode, and the metal foil is joined to a region including the end portion in the first direction of the electrode. Further, it is preferable to use welding as a joining method, in order to reduce the electric resistance. The width for welding the metal foil is preferably less than or equal to 10 mm, because, if the width is too wide, a useless space within a battery is increased, and the capacity density of the battery is reduced. The width for welding the metal foil is preferably more than or equal to 1 mm, because, if the width is too narrow, it is difficult to weld the metal foil, and the effect of collecting power is also reduced.

While methods such as resistance welding and ultrasonic welding can be used as a welding method, ultrasonic welding is preferable because of a larger bonding area.

—Metal Foil—

Considering the electric resistance and the resistance to an electrolytic solution, aluminum is preferable as a material for the metal foil. Further, it is preferable to use an aluminum foil having a purity of 99.99% or more, because, if the metal foil contains an impurity, the impurity elutes and reacts within a battery or a capacitor. Furthermore, the thickness of a welded portion is preferably thinner than the thickness of the electrode itself. The thickness of the aluminum foil is preferably 10 to 500 μm.

In addition, although the metal foil may be welded before or after charging the active material into the power collector, welding before charging can suppress falling of the active material. In particular in the case of ultrasonic welding, welding before charging is preferable. Moreover, although activated carbon paste may be attached to the welded portion, it may exfoliate during the step, and thus it is preferable to provide masking to prevent charging.

It should be noted that, although the step of compressing the end portion and the step of joining the tab lead have been described as separated steps in the above description, the step of compressing the end portion and the step of joining the tab lead may be performed simultaneously. In this case, a roller whose roller portion in contact with the end portion for joining the tab lead of the three-dimensional network metal porous body sheet can perform resistance welding is used as a compression roller, and the three-dimensional network metal porous body sheet and the metal foil are supplied simultaneously to the roller, so that compression of the end portion and welding of the metal foil to the compression portion can be performed simultaneously.

(Step of Charging Carbon Nanotubes and Ionic Liquid)

The kneaded material containing the carbon nanotubes and the ionic liquid is charged into the power collector obtained as described above, by the same method as the (Step of Charging Kneaded Material into Pore Portions of Three-dimensional Network Metal Porous Body) described above, to obtain an electrode.

(Compression Step)

The electrode material is compressed to have a final thickness in the compression step. As a pressing machine, a flat plate press or a roller press is used. Since a flat plate press is preferable to suppress elongation of a power collector but is not suitable for mass production, it is preferable to use a roller press which can continuously perform processing. In a case where a roller press is used, for example, after the kneaded material is charged into the three-dimensional network metal porous body, ionic liquid absorbers are placed on both sides of the three-dimensional network metal porous body, and thereafter the three-dimensional network metal porous body is uniaxially rolled in the thickness direction by applying a pressure of about 30 MPa to 450 MPa. During rolling, an excessive ionic liquid is drained from the kneaded material charged in the three-dimensional network metal porous body, and is absorbed into the ionic liquid absorbers. Accordingly, the concentration of the active material in the kneaded material remaining in the three-dimensional network metal porous body is increased. Thus, in the power storage device using the electrode, the discharging capacity per unit area of the electrode (mAh/cm²) and the output per unit area of the electrode (W/cm²) can be increased.

The thickness of the electrode is preferably set to be in a range of more than or equal to 0.2 mm and less than or equal to 1.0 mm, from the viewpoint of the discharging capacity per unit area of the electrode. Further, the thickness of the electrode is preferably set to be in a range of more than or equal to 0.05 mm and less than or equal to 0.5 mm, from the viewpoint of the output per unit area of the electrode.

(Cutting Step)

In order to improve the mass productivity of the electrode material, it is preferable to cut a sheet of the three-dimensional network metal porous body having a width for a plurality of final products, along a traveling direction of the sheet, using a plurality of cutting edges, to obtain a plurality of long sheet-shaped electrode materials. This cutting step is the step of dividing a long electrode material into a plurality of long electrode materials.

(Take-Up Step)

This step is the step of taking up the plurality of long sheet-shaped electrode materials obtained in the above cutting step, on a take-up roller.

### Second Embodiment

### Electric Double Layer Capacitor

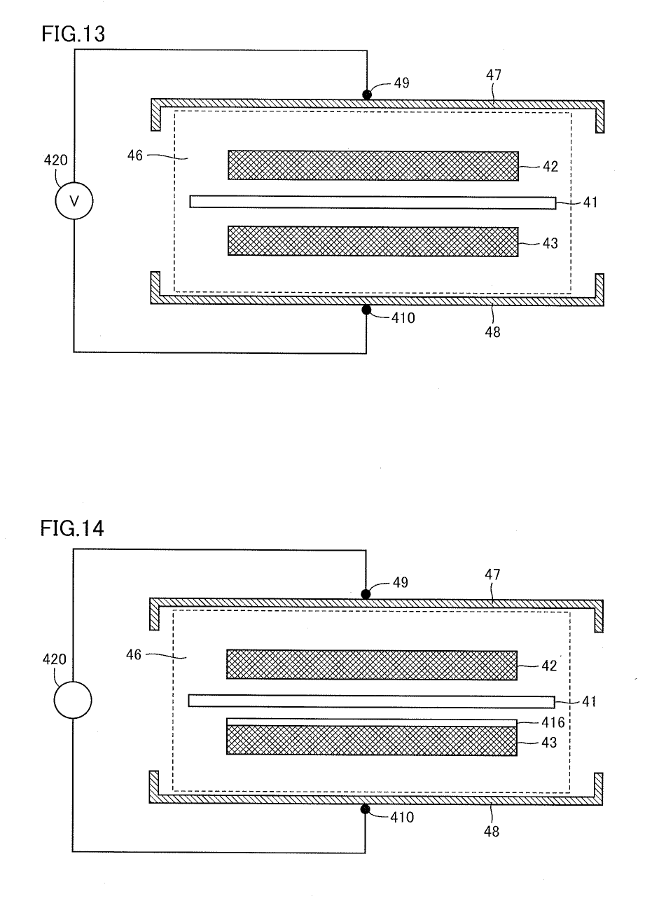

An electric double layer capacitor in one embodiment of the present invention will be described with reference to FIG. 13.

In the electric double layer capacitor, a positive electrode 42 and an negative electrode 43 are arranged with a separator 41 sandwiched therebetween. Separator 41, positive electrode 42, and negative electrode 43 are sealed in a space between an upper cell case 47 and a lower cell case 48 filled with an electrolytic solution 46. Terminals 49 and 410 are provided to upper cell case 47 and lower cell case 48, respectively. Terminals 49 and 410 are connected to a power source 420.

In the electric double layer capacitor in one embodiment of the present invention, the electrode for the power storage device in one embodiment of the present invention can be used for the positive electrode and the negative electrode.

As the electrolytic solution, the ionic liquid used for the electrode for the power storage device can be used. As the separator for the electric double layer capacitor, a porous film having a high electrical insulation property made of, for example, polyolefin, polyethylene terephthalate, polyamide, polyimide, cellulose, glass fiber, or the like can be used.

(Method for Manufacturing Electric Double Layer Capacitor)

First, two electrodes are prepared by punching them from the electrode for the power storage device in one embodiment of the present invention so as to have an appropriate size, and are arranged to face each other with the separator sandwiched therebetween. Then, they are housed in a cell case, and are impregnated with the electrolytic solution. Finally, the case is covered with a lid and sealed, and thereby the electric double layer capacitor can be fabricated. In order to reduce the moisture within the capacitor limitlessly, fabrication of the capacitor is performed under an environment with little moisture, and sealing is performed under a reduced pressure environment. It should be noted that the electric double layer capacitor may be fabricated by any other method, as long as it uses the electrode for the power storage device in one embodiment of the present invention.

### Third Embodiment

### Lithium Ion Capacitor

A lithium ion capacitor in one embodiment of the present invention will be described with reference to FIG. 14.

The structure of the lithium ion capacitor is basically identical to the structure of the electric double layer capacitor, except that a lithium metal foil 416 is pressure-bonded on a surface of negative electrode 43 facing positive electrode 42.

In the lithium ion capacitor in one embodiment of the present invention, the electrode for the power storage device in one embodiment of the present invention can be used for the positive electrode and the negative electrode. Further, the negative electrode is not particularly limited, and a conventional negative electrode using a metal foil can also be used.

As the electrolytic solution, the ionic liquid containing a lithium salt used for the electrode for the power storage device can be used. A lithium metal foil for lithium doping is pressure-bonded on the negative electrode.

In the lithium ion capacitor, it is preferable that the capacity of the negative electrode is larger than the capacity of the positive electrode, and the occlusion amount of lithium ions by the negative electrode is less than or equal to 90% of the difference between the capacity of the positive electrode and the capacity of the negative electrode. The occlusion amount of lithium ions can be adjusted by the thickness of the lithium metal foil pressure-bonded on the negative electrode.

(Method for Manufacturing Lithium Ion Capacitor)

First, positive and negative electrodes are prepared by punching them from the electrode for the power storage device in one embodiment of the present invention so as to have an appropriate size, and the lithium metal foil is pressure-bonded on the negative electrode. Next, the positive and negative electrodes are arranged to face each other with the separator sandwiched therebetween. On this occasion, the negative electrode is arranged such that its surface having the lithium metal foil pressure-bonded thereon faces the positive electrode. Then, they are housed in a cell case, and are impregnated with the electrolytic solution. Finally, the case is covered with a lid and sealed, and thereby the lithium ion capacitor can be fabricated.

It should be noted that, for lithium doping, the lithium ion capacitor is left at an environmental temperature of 0° C. to 60° C. for 0.5 hours to 100 hours, with the electrolytic solution being injected. When the potential difference between the positive and negative electrodes becomes less than or equal to 2 V, it can be determined that lithium doping is completed.

It should be understood that the embodiments disclosed herein are illustrative and non-restrictive in every respect. The scope of the present invention is defined by the scope of the claims, rather than the description above, and is intended to include any modifications within the scope and meaning equivalent to the scope of the claims.

### Example 1

In the present example, the relation between the orientation of pore portions exposed at a surface of a three-dimensional network metal porous body and the electric resistance of an electrode which used the three-dimensional network metal porous body as well as the energy density of an electric double layer capacitor which used the electrode was evaluated.

### Example 1-1

### Preparation of Three-Dimensional Network Metal Porous Body

(Formation of Conductive Layer on Surface of Resin Porous Body)

As a urethane resin porous body, a urethane foam having a porosity of 95%, about 50 pores per inch, a pore diameter of about 550 μm, and a thickness of 1 mm was prepared, and was cut into 100 mm by 30 mm pieces. On the surface of this polyurethane foam, an aluminum film having a basis weight of 10 g/m² was formed as a conductive layer, by a sputtering method.

(Molten Salt Plating)

The urethane foam having the conductive layer formed on its surface was set as a workpiece in a jig having a power feeding function, then was placed within a glove box having an argon atmosphere and a low moisture (dew point: less than or equal to −30° C.), and was immersed in a molten salt aluminum plating bath (33 mol % EMIC-67 mol % AlCl₃) at a temperature of 40° C. On this occasion, two rollers were provided in a separated reverse V shape on the workpiece, and molten salt plating was performed while widening the workpiece such that a tension of 65 kPa was applied in the width direction of the workpiece. The jig in which the workpiece was set was connected to a cathode side of a rectifier, and an aluminum plate (purity: 99.99%) as a counter electrode was connected to an anode side of the rectifier. Plating was performed by applying a direct current having a current density of 3.6 A/dm² for 90 minutes, to obtain an aluminum structural body in which an aluminum plating layer with a weight of 150 g/m² was formed on the surface of the urethane foam. Stirring was performed in a stirrer, using a rotor made of Teflon (registered trademark). Here, the current density was calculated based on the apparent area of the urethane foam.

(Removal of Resin Porous Body)

Said aluminum structural body was immersed in a LiCl—KCl eutectic molten salt at a temperature of 500° C., and an negative potential of −1 V was applied for 30 minutes. In the molten salt, air bubbles were generated by a decomposition reaction of polyurethane. Then, the resultant body was cooled to room temperature in the atmosphere, and thereafter washed with water to remove the molten salt. Thereby, an aluminum porous body (three-dimensional network metal porous body) with the resin having been removed therefrom was obtained. The obtained aluminum porous body had communication pores, and had a porosity of 96%.

In the following description, the width direction (30 mm) of the aluminum porous body is defined as the first direction, and the longitudinal direction (100 mm) of the aluminum porous body is defined as the second direction.

(Welding of Tab Lead to Aluminum Porous Body)

The thickness of the obtained aluminum porous body was adjusted to 0.96 mm by a roller press, and the aluminum porous body was cut into 5 cm pieces.

In order to prepare for welding, a 5 mm-wide SUS block (bar) and a hammer were used as jigs for compression. The SUS block was placed at a position 5 mm from the edge of one side which was parallel to the first direction or the second direction of the aluminum porous body, and the SUS block was struck with the hammer to compress the aluminum porous body, thereby forming a 100 μm-thick compression portion.

Thereafter, a tab lead was welded to the compression portion by spot welding, under the following conditions:

### —Welding Conditions—

welding apparatus: Hi-Max 100 manufactured by Panasonic Corporation, model number YG-101UD (capable of applying up to 250 V)

capacity 100 Ws, 0.6 kVA

electrode: a copper electrode of 2 mmφ

load: 8 kgf

voltage: 140 V

### —Tab Lead—

material: aluminum

dimensions: 5 mm in width, 7 cm in length, and 100 μm in thickness

surface state: Boehmite treated

<Preparation of Kneaded Material>

A single-layer CNT (“SO—P” manufactured by Meijo Nano Carbon (purity: 98.3% by mass, form: single-layer CNT, length: 1 to 5 μm, average diameter: 1.4 nm)) and EMI-BF₄ (“1-ethyl-3-methylimidazolium tetrafluoroborate” manufactured by Kishida Chemical Co., Ltd.) were prepared such that the amount of the single-layer CNT was 7% by mass of the total mass of the single-layer CNT and EMI-BF₄. Next, the single-layer CNT and EMI-BF₄ were kneaded for 10 minutes using a mortar to obtain a kneaded material.

<Fabrication of Electrode for Power Storage Device>

The kneaded material was placed on an upper surface of the aluminum porous body, and was rubbed into pore portions of the porous body in a direction parallel to the first direction, using a squeegee, to obtain an electrode for a power storage device.

(Measurement of Pore Portions of Electrode for Power Storage Device)

The pore portion diameter of pore portions exposed at a surface of the electrode for the power storage device was measured. The pore portion diameter was measured by shaving the surface of the electrode for the power storage device to such an extent that the skeleton of the three-dimensional network metal porous body could be observed, then magnifying the surface of the three-dimensional network metal porous body using a micrograph or the like, drawing a straight line of 1 inch (25.4 mm) in each of the first direction and the second direction, counting the number of pore portions which cross each straight line, and calculating each average value, as the pore portion diameter (D) in the first direction=25.4 mm/the number of pore portions in the first direction, and the pore portion diameter (d) in the second direction=25.4 mm/the number of pore portions in the second direction. In addition, the number of pore portions present in a 1 inch square and the number of pore portions satisfying 0<d/D<1 were counted to calculate the rate (%) of pore portions satisfying 0<d/D<1.

(Measurement of Electric Resistance of Electrode for Power Storage Device)

The electric resistance of the electrode for the power storage device was measured. The measurement of the electric resistance was performed using a four-terminal method, by bringing terminals made of a copper plate having a width of 5 mm and a thickness of 0.1 mm into contact with the electrode for the power storage device cut to have a width of 10 mm, at a load of 3 kg/cm². The distance between electrodes was set to 50 mm.

Table 1 shows the results.

<Fabrication of Electric Double Layer Capacitor>

From the obtained electrode for the power storage device, two electrodes each having the tab lead joined in a region including an end portion in the first direction were prepared as positive and negative electrodes. These electrodes were arranged to face each other with a cellulose fiber separator (“TF4035” manufactured by Nippon Kodoshi Corporation, thickness: 35 μm) sandwiched therebetween, and were housed in a coin cell case of type 82032. Next, EMI-BF₄ was injected as an electrolytic solution into the coin cell case, and then the case was sealed to fabricate a coin-type electric double layer capacitor.

(Evaluation of Performance of Electric Double Layer Capacitor)

The electric double layer capacitor was charged to 3.5 V, using a constant current of 1 A/g (current amount per mass of carbon nanotubes contained in a single electrode), at an environmental temperature of 25° C., and then charging at a constant voltage of 3.5 V was performed for 5 minutes. Thereafter, the electric double layer capacitor was discharged to 0 V, using a constant current of 1 A/g (current amount per mass of carbon nanotubes contained in a single electrode), to evaluate electrostatic capacitance on that occasion. In Table 1, the electrostatic capacitance (F/g) is indicated as an electrostatic capacitance per mass of carbon nanotubes contained in a single electrode. Further, energy density WD (Wh/L) on that occasion is also indicated. The energy density was calculated using the following equation (2):

WD=W/V (2),

where W indicates energy stored in the capacitor, and V indicates volume. It should be noted that volume V is a capacitor volume without taking the coin cell case into consideration.

Table 1 shows the results.

### Example 1-2

An electrode for a power storage device was obtained as in Example 1-1, except that the kneaded material was rubbed in a direction parallel to the second direction when the electrode for the power storage device in Example 1-1 was fabricated. The same measurement as that in Example 1-1 was performed on the obtained electrode. Further, from the obtained electrode for the power storage device, electrodes each having a tab lead joined in the region including the end portion in the first direction were prepared and used to fabricate an electric double layer capacitor, and the same evaluation as that in Example 1-1 was performed thereon.

Table 1 shows the results.

### Example 1-3

An aluminum porous body was obtained as in Example 1-1, except that the tension applied in the width direction (the first direction) of the workpiece was set to 125 kPa in the molten salt plating of Example 1-1.

Using the obtained aluminum porous body, an electrode for a power storage device was fabricated as in Example 1-1, and the same measurement as that in Example 1-1 was performed thereon. Further, an electric double layer capacitor was fabricated using the obtained electrode, and the same evaluation as that in Example 1-1 was performed thereon.

Table 1 shows the results.

### Example 1-4

### Preparation of Three-Dimensional Network Metal Porous Body

As a urethane resin porous body, a urethane foam was used. The urethane foam had been influenced by gravity during foaming, and had an average pore diameter of 552 urn in the gravity direction, and an average pore diameter of 508 in the horizontal direction. This urethane resin porous body was sliced along a plane inclined by 30 degrees with respect to the horizontal direction to have a thickness of 1 mm, to obtain a foamed urethane sheet having the pore portion diameter (D) in the first direction of 508 μm and the pore portion diameter (d) in the second direction of 440 μm. Using said foamed urethane sheet, an aluminum porous body was obtained by plating aluminum and removing urethane as in Example 1-1, without using a separated reverse V shape roller.

Using the obtained aluminum porous body, an electrode for a power storage device was fabricated as in Example 1-1, and the same measurement as that in Example 1-1 was performed thereon. Further, from the obtained electrode for the power storage device, electrodes each having a tab lead joined in the region including the end portion in the first direction were prepared and used to fabricate an electric double layer capacitor, and the same evaluation as that in Example 1-1 was performed thereon. Table 1 shows the results.

### Comparative Example 1-1

An aluminum porous body was obtained as in Example 1-1, except that no tension was applied on the workpiece in the molten salt plating of Example 1-1.

Using the obtained aluminum porous body, an electrode for a power storage device was fabricated as in Example 1-1, and the same measurement as that in Example 1-1 was performed thereon. Further, from the obtained electrode for the power storage device, electrodes each having a tab lead joined in the region including the end portion in the first direction were prepared and used to fabricate an electric double layer capacitor, and the same evaluation as that in Example 1-1 was performed thereon.

Table 1 shows the results.

TABLE 1

| | Three-dimensional network | | | | | | | | | | | |
|---|---|---|---|---|---|---|---|---|---|---|---|---|
| | metal porous body | | | | | | | | | | | |
| | Pore portions exposed at surface | | | | Electrode | | | | Electric double layer capacitor | | | |
| | Rate of pore | Cell | Cell | | | | | Content of | Oper- | | | |
| | portions | diameter | diameter | | Electric resistance | | | CNT in | ating | | | |
| | satisfying | in first | in second | | First | Second | | single | voltage | Charging | Electrostatic | Energy |
| | 0 < d/D < 1 | direction | direction | | direction | direction | | electrode | range | voltage | capacitance | density |
| | (%) | (D) | (d) | d/D | (R1) | (R2) | R2/R1 | (mg) | (V) | (V) | (F/g) | (Wh/L) |
| Example 1-1 | 97 | 552 | 438 | 0.79 | 15.6 | 18.5 | 1.19 | 72.3 | 0-3.5 | 3.5 | 77 | 5.4 |
| Example 1-2 | 96 | 552 | 438 | 0.79 | 15.5 | 18.6 | 1.20 | 70.5 | 0-3.5 | 3.5 | 75 | 5.1 |
| Example 1-3 | 98 | 635 | 438 | 0.69 | 14.3 | 18.7 | 1.31 | 73.7 | 0-3.5 | 3.5 | 76 | 5.4 |
| Example 1-4 | 95 | 508 | 440 | 0.87 | 16.0 | 17.9 | 1.12 | 71.2 | 0-3.5 | 3.5 | 74 | 5.1 |
| Comparative | — | 529 | 552 | 1.04 | 16.7 | 15.7 | 0.94 | 71.5 | 0-3.5 | 3.5 | 67 | 4.6 |
| Example 1-1 | | | | | | | | | | | | |

<Evaluation Results>

It was confirmed that the electrodes in Examples 1-1 to 1-4 have electric resistances in the first direction lower than that of the electrode in Comparative Example 1-1.

It was confirmed that the electric double layer capacitors in Examples 1-1 to 1-4 have electrostatic capacitances and energy densities greater than those of the electrode in Comparative Example 1-1.

When comparison was made between Example 1-1 and Example 1-2, it was confirmed that the content of the carbon nanotubes in the electrode is greater in Example 1-1. This seems to be because the kneaded material was rubbed into the aluminum porous body in the direction parallel to the first direction in Example 1-1, and thus the carbon nanotubes easily entered the pore portions of the aluminum porous body.

### Example 2

In the present example, the relation between the orientation of pore portions exposed at a surface of a three-dimensional network metal porous body and the orientation of carbon nanotubes was evaluated.

### Example 1-1

The same electrode and electric double layer capacitor as those in Example 1-1 were fabricated, and the same evaluation as that in Example 1-1 was performed thereon.

Table 2 shows the results.

### Example 2-1

After the same electrode as that in Example 1-1 was fabricated, a voltage was applied parallel to the first direction of the electrode, to orient the length direction of the carbon nanotubes charged in the pore portions of the aluminum porous body to be parallel to the first direction. It should be noted that the orientation of the carbon nanotubes was confirmed by a change in electric resistance.

The same measurement as that in Example 1-1 was performed on the obtained electrode. Further, an electric double layer capacitor was fabricated using the electrode, and the same evaluation as that in Example 1-1 was performed thereon.

Table 2 shows the results.

### Example 2-2

After the same electrode as that in Example 1-1 was fabricated, a magnetic field was applied parallel to the second direction of the electrode, to orient the length direction of the carbon nanotubes charged in the pore portions of the aluminum porous body to be parallel to the second direction.

The same measurement as that in Example 1-1 was performed on the obtained electrode. Further, an electric double layer capacitor was fabricated using the electrode, and the same evaluation as that in Example 1-1 was performed thereon.

Table 2 shows the results.

TABLE 2

| | Electrode | | | | | Electric double layer capacitor | | | |
|---|---|---|---|---|---|---|---|---|---|
| | | Electric resistance | | | | Operating | | | |
| | Direction of | First | | | Content of | voltage | Charging | Electrostatic | Energy |
| | orientation of | direction | Second direction | | CNT in single | range | voltage | capacitance | density |
| | CNT | (R1) | (R2) | R2/R1 | electrode (mg) | (V) | (V) | (F/g) | (Wh/L) |
| Example 1-1 | No orientation | 15.6 | 18.5 | 1.19 | 72.3 | 0-3.5 | 3.5 | 77 | 5.4 |
| Example 2-1 | First direction | 12.2 | 18.9 | 1.55 | 72.5 | 0-3.5 | 3.5 | 86 | 6.0 |
| Example 2-2 | Second direction | 14.7 | 16.5 | 1.12 | 72.1 | 0-3.5 | 3.5 | 78 | 5.4 |

<Evaluation Results>

In Example 2-1, the length direction of the carbon nanotubes was oriented in the first direction, and it was confirmed that the electrode has a lower electric resistance and the capacitor has a greater energy density, when compared with Example 1-1 and Example 2-2.

### Example 3

In the present example, the relation between the orientation of pore portions exposed at a surface of a three-dimensional network metal porous body and the electric resistance of an electrode which used the three-dimensional network metal porous body as well as the energy density of a lithium ion capacitor which used the electrode was evaluated.

### Example 3-1

The same electrode for the power storage device as that in Example 1-1 was prepared. The pore portions and electric resistance of the obtained electrode for the power storage device were measured by the same method as that in Example 1-1

<Fabrication of Lithium Ion Capacitor>

(Fabrication of Positive Electrode)

From the obtained electrode for the power storage device, an electrode having a tab lead joined in the region including the end portion in the first direction was prepared as a positive electrode.

(Fabrication of Negative Electrode)

Hard carbon and EMI-FSI were prepared such that the amount of hard carbon was 7% by mass of the total amount of hard carbon and EMI-FSI. Next, hard carbon and EMI-FSI were kneaded for 10 minutes using a mortar to obtain a kneaded material for an negative electrode.

A three-dimensional network nickel porous body (average pore diameter: 480 μm, porosity: 95%, thickness: 1.4 mm) was, prepared, and compressed to a thickness of 200 μm by a roll press. Next, the kneaded material for an negative electrode was placed on an upper surface of the three-dimensional network nickel porous body, and was rubbed toward a lower surface, using a squeegee, to fabricate an negative electrode.

(Fabrication of Lithium ion Capacitor)

The obtained positive and negative electrodes were arranged to face each other with a cellulose fiber separator (“TF4035” manufactured by Nippon Kodoshi Corporation, thickness: 35 μm) sandwiched therebetween, and were housed in a coin cell case of type R2032. It should be noted that a lithium metal foil was pressure-bonded beforehand on a surface of the negative electrode facing the positive electrode. The thickness of the lithium metal foil was set such that the lithium metal foil had a capacity which was 90% of the difference between the capacity of the positive electrode and the capacity of the negative electrode (=the capacity of the negative electrode—the capacity of the positive electrode) determined from the amount of the single-layer CNT charged in the three-dimensional network aluminum porous body.

Next, EMI-FSI in which lithium-bis(trifluoromethane sulfonyl)imide (LiTFSI) was dissolved at a concentration of 1.0 mol/L was injected as an electrolytic solution into the coin cell case, and then the case was sealed to fabricate a coin-type lithium ion capacitor.

Next, for lithium doping, the lithium ion capacitor was left at an environmental temperature of 60° C. for 40 hours. When the potential difference between the positive and negative electrodes became more than or equal to 2 V, it was determined that lithium doping was completed.

(Evaluation of Performance of Lithium Ion Capacitor)

The lithium ion capacitor was charged with 1 A/g (current amount per mass of carbon nanotubes in the positive electrode), and discharged with 1 A/g (current amount per mass of carbon nanotubes in the positive electrode), in a voltage range indicated in Table 3, at an environmental temperature of 25° C., to evaluate electrostatic capacitance and energy density. In Table 3, the electrostatic capacitance (F/g) is indicated as an electrostatic capacitance per mass of carbon nanotubes contained in the positive electrode. It should be noted that energy density WD (Wh/L) was calculated using the above equation (2).

Table 3 shows the results.

### Example 3-2

The same electrode for the power storage device as that in Example 1-2 was prepared. The pore portions and electric resistance of the obtained electrode for the power storage device were measured by the same method as that in Example 1-1.

<Fabrication of Lithium Ion Capacitor>

A lithium ion capacitor was fabricated by the same method as that in Example 3-1, except that an electrode having a tab lead joined in the region including the end portion in the first direction was prepared from the obtained electrode for the power storage device and used as a positive electrode, and the same evaluation as that in Example 3-1 was performed thereon.

### Example 3-3

The same electrode for the power storage device as that in Example 1-3 was prepared. The pore portions and electric resistance of the obtained electrode for the power storage device were measured by the same method as that in Example 1-1.

<Fabrication of Lithium Ion Capacitor>

A lithium ion capacitor was fabricated by the same method as that in Example 3-1, except that an electrode having a tab lead joined in the region including the end portion in the first direction was prepared from the obtained electrode for the power storage device and used as a positive electrode, and the same evaluation as that in Example 3-1 was performed thereon.

Table 3 shows the results.

### Example 3-4

The same electrode for the power storage device as that in Example 1-4 was prepared. The pore portions and electric resistance of the obtained electrode for the power storage device were measured by the same method as that in Example 1-1.

<Fabrication of Lithium Ion Capacitor>

A lithium ion capacitor was fabricated by the same method as that in Example 3-1 except that an electrode having a tab lead joined in the region including the end portion in the first direction was prepared from the obtained electrode for the power storage device and used as a positive electrode, and the same evaluation as that in Example 3-1 was performed thereon.

Table 3 shows the results.

### Comparative Example 3-1

The same electrode for the power storage device as that in Comparative Example 1-1 was prepared. The pore portions and electric resistance of the obtained electrode for the power storage device were measured by the same method as that in Example 1-1.

<Fabrication of Lithium Ion Capacitor>

A lithium ion capacitor was fabricated by the same method as that in Example 3-1, except that an electrode having a tab lead joined in the region including the end portion in the first direction was prepared from the obtained electrode for the power storage device and used as a positive electrode, and the same evaluation as that in Example 3-1 was performed thereon.

Table 3 shows the results.

TABLE 3

| | Three-dimensional network | | | | | | | | | | | |
|---|---|---|---|---|---|---|---|---|---|---|---|---|
| | metal porous body | | | | | | | | | | | |
| | Pore portions exposed at surface | | | | Electrode | | | | Lithium ion capacitor | | | |
| | Rate of pore | Cell | Cell | | | | | Content of | Oper- | | | |
| | portions | diameter | diameter | | Electric resistance | | | CNT in | ating | | | |
| | satisfying | in first | in second | | First | Second | | single | voltage | Charging | Electrostatic | Energy |
| | 0 < d/D < 1 | direction | direction | | direction | direction | | electrode | range | voltage | capacitance | density |
| | (%) | (D) | (d) | d/D | (R1) | (R2) | R2/R1 | (mg) | (V) | (V) | (F/g) | (Wh/L) |
| Example 3-1 | 97 | 552 | 438 | 0.79 | 15.6 | 18.5 | 1.19 | 72.3 | 3-4.8 | 4.8 | 76 | 5.0 |
| Example 3-2 | 96 | 552 | 438 | 0.79 | 15.5 | 18.6 | 1.20 | 70.5 | 3-4.8 | 4.8 | 75 | 4.8 |
| Example 3-3 | 98 | 635 | 438 | 0.69 | 14.3 | 18.7 | 1.31 | 73.7 | 3-4.8 | 4.8 | 77 | 5.1 |
| Example 3-4 | 95 | 508 | 440 | 0.87 | 16.0 | 17.9 | 1.12 | 71.2 | 3-4.8 | 4.8 | 75 | 4.8 |
| Comparative | — | 529 | 552 | 1.04 | 16.7 | 15.7 | 0.94 | 71.5 | 3-4.8 | 4.8 | 67 | 4.3 |
| Example 3-1 | | | | | | | | | | | | |

<Evaluation Results>

It was confirmed that the electrodes in Examples 3-1 to 3-4 have electric resistances in the first direction lower than that of the electrode in Comparative Example 3-1.

It was confirmed that the electric double layer capacitors in Examples 3-1 to 3-4 have electrostatic capacitances and energy densities greater than those of the electrode in Comparative Example 3-1.

When comparison was made between Example 3-1 and Example 3-2, it was confirmed that the content of the carbon nanotubes in the electrode is greater in Example 1. This seems to be because the kneaded material was rubbed into the aluminum porous body in the first direction in Example 3-1, and thus the carbon nanotubes easily entered the pore portions of the aluminum porous body.

### INDUSTRIAL APPLICABILITY

The power storage device using the electrode for the power storage device of the present invention can be used for various applications including, for example, transportation equipment such as a vehicle and a train.

### REFERENCE SIGNS LIST

1, 4, 34: three-dimensional network metal porous body; 3: tab lead; 6: pore portion; 11: resin porous body; 12: conductive layer; 13: plating layer; 22: belt-like resin; 23, 28: plating bath; 24: cylindrical electrode; 25, 27: anode; 26: electrode roller; 33: compression portion; 35: rotary roller; 41: separator; 42: positive electrode; 43: negative electrode; 46: electrolytic solution; 47: upper cell case; 48: lower cell case; 49, 410: terminal; 416: lithium metal foil; 420: power source.

1. An electrode for a power storage device, comprising:
carbon nanotubes;
an ionic liquid; and
a three-dimensional network metal porous body having a plurality of pore portions filled with said carbon nanotubes and said ionic liquid, wherein
in pore portions exposed at a surface of said three-dimensional network metal porous body, of said plurality of pore portions, a ratio (d/D) between a pore portion diameter (D) in a first direction within the surface of said three-dimensional network metal porous body and a pore portion diameter (d) in a second direction orthogonal to said first direction within the surface of said three-dimensional network metal porous body is in a range of 0<d/D<1, and
pore portions in said range account for more than or equal to 95% and less than or equal to 100% of the pore portions exposed at said surface.

2. The electrode for a power storage device according to claim 1, wherein the ratio (d/D) between the pore portion diameter (D) in said first direction and the pore portion diameter (d) in said second direction is in a range of 0.3≦d/D≦0.8.

3. The electrode for a power storage device according to claim 1, wherein a length direction of said carbon nanotubes is substantially parallel to said first direction.

4. A power storage device, comprising an electrode for a power storage device as recited in claim 1.

5. The power storage device according to claim 4, formed by joining, to said three-dimensional network metal porous body, a tab lead which collects power in said first direction.

6. A method for manufacturing an electrode for a power storage device, comprising the steps of:
kneading carbon nanotubes and an ionic liquid to produce a kneaded material; and
charging said kneaded material into pore portions of a three-dimensional network metal porous body having a plurality of pore portions, wherein
in pore portions exposed at a surface of said three-dimensional network metal porous body, of said plurality of pore portions, a ratio (d/D) between a pore portion diameter (D) in a first direction within the surface of said three-dimensional network metal porous body and a pore portion diameter (d) in a second direction orthogonal to said first direction within the surface of said three-dimensional network metal porous body is in a range of 0<d/D<1, and
pore portions in said range account for more than or equal to 95% and less than or equal to 100% of the pore portions exposed at said surface.
